(19) United States
(12) Patent Application Publication
(10) Pub. No.: US 2025/0350029 A1
(43) Pub. Date: Nov. 13, 2025

(54) HYBRID ANTENNA SUBSTRATE

(71) Applicant: LG INNOTEK CO., LTD., Seoul (KR)

(72) Inventors: Ji Hun HA, Seoul (KR); Chi Sang YOU, Seoul (KR); Doo Chan JUNG, Seoul (KR)

(73) Assignee: LG INNOTEK CO., LTD., Seoul (KR)

(21) Appl. No.: 18/870,587

(22) PCT Filed: May 31, 2023
(86) PCT No.: PCT/KR2023/007434

§ 371 Date: Nov. 29, 2024

(30) Foreign Application Priority Data
May 31, 2022 (KR) 10-2022-0066617

(51) Int. Cl. H01Q 9/04; H01Q 1/38

(52) U.S. Cl. CPC H01Q 9/0407; H01Q 1/38

(57) ABSTRACT

A hybrid antenna substrate of an embodiment comprises: a core part including a core layer and a core wiring layer laminated in the vertical direction; and an antenna part disposed on the core part, wherein: the antenna part comprises a plurality of antenna wiring layers successively laminated on the core part and antenna insulating layers disposed between the plurality of antenna wiring layers; and the core layer has a greater dielectric constant than the antenna insulating layers.

### TECHNICAL FIELD

Embodiments relate to a hybrid antenna substrate.

### BACKGROUND ART

Recently, efforts have been made to develop an improved 5^{th} generation (5G) or pre-5G communication system in order to meet the demand for wireless data traffic.

To achieve a high data transfer rate, the 5G communication system uses millimeter wave (mmWave) bands (sub-6 GHZ, 28 GHZ, 38 GHZ, or higher frequencies). This high frequency band is called mmWave due to the wavelength thereof.

In order to reduce path loss of radio waves and increase a transmission distance of radio waves in the ultra-high frequency band, integration technologies such as beamforming, massive multiple-input multiple-output (MIMO), and array antennas have been developed in the 5G communication system.

The size of antenna systems may relatively increase because hundreds of active antennas are required to cover the above frequency bands.

However, an antenna needs to be reduced in size in order to be mounted in smartphones or the like, and therefore, various research with the goal of increasing the bandwidth of an antenna without increasing the size thereof is underway.

### DISCLOSURE

### Technical Problem

Embodiments provide a hybrid antenna substrate having a compact size and a wide bandwidth.

### Technical Solution

A hybrid antenna substrate according to an embodiment may include a core unit including a core layer and a core wiring layer stacked in a vertical direction and an antenna unit disposed on the core unit, wherein the antenna unit may include a plurality of antenna wiring layers sequentially stacked on the core unit and an antenna insulating layer disposed between the plurality of antenna wiring layers, and the core layer may have a higher dielectric constant than the antenna insulating layer.

In an example, the antenna wiring layers may include a short-range patch antenna and a long-range patch antenna disposed farther away from the core unit in the vertical direction than the short-range patch antenna, the long-range patch antenna having a smaller surface area than the short-range patch antenna. The antenna insulating layer may include a short-range insulating layer located under the short-range patch antenna and a long-range insulating layer located under the long-range patch antenna, and the long-range insulating layer may have a lower dielectric constant than the short-range insulating layer.

In an example, the plurality of antenna wiring layers may include a lower wiring layer disposed on the core unit and an intermediate wiring layer disposed on the lower wiring layer.

In an example, one of the lower wiring layer and the intermediate wiring layer may include a low-band patch antenna, and the remaining one of the lower wiring layer and the intermediate wiring layer may include a high-band patch antenna.

In an example, the plurality of antenna wiring layers further include an upper wiring layer disposed on the may intermediate wiring layer.

In an example, one of the lower wiring layer, the intermediate wiring layer, and the upper wiring layer may include a low-band patch antenna, another of the lower wiring layer, the intermediate wiring layer, and the upper wiring layer may include a high-band patch antenna, and the remaining one of the lower wiring layer, the intermediate wiring layer, and the upper wiring layer may include an additional patch antenna.

In an example, the additional patch antenna may include a first conductive antenna pattern layer having a polygonal, circular, or elliptical planar shape.

In an example, the additional patch antenna may include a second conductive antenna pattern layer having a polygonal, circular, or elliptical planar shape with an open cavity therein.

In an example, the additional patch antenna may include a third conductive antenna pattern layer having a plurality of planar patterns formed on the same plane.

In an example, the additional patch antenna may include, in combination, at least two of a first conductive antenna pattern layer having a polygonal, circular, or elliptical planar shape, a second conductive antenna pattern layer having a polygonal, circular, or elliptical planar shape with an open cavity therein, and a third conductive antenna pattern layer having a plurality of planar patterns formed on the same plane.

In an example, the plurality of antenna wiring layers may include first to M^{th} (here M being a positive integer greater than or equal to 2) wiring layers sequentially stacked in the vertical direction from the core unit, the antenna insulating layer may include first to Nth (1≤N≤M−1) insulating layers having first to Nth dielectric constants, respectively, and an n^{th} (1≤n≤N) insulating layer may be disposed between the n^{th} wiring layer and the n+1^{th} wiring layer.

In an example, at least one of the first to Nth dielectric constants may be lower than the dielectric constant of the core layer.

In an example, the first to Nth dielectric constants may be equal to each other.

In an example, at least one of the first to Nth dielectric constants may be different from the others.

In an example, the magnitudes of the first to Nth dielectric constants may gradually decrease in that order.

In an example, the first dielectric constant may be equal to or higher than the dielectric constant of the core layer, and each of the second to Nth dielectric constants may be lower than the dielectric constant of the core layer.

In an example, each of the first and second dielectric constants may be equal to or higher than the dielectric constant of the core layer, and each of the third to Nth dielectric constants may be lower than the dielectric constant of the core layer.

In an example, the hybrid antenna substrate may further include a routing unit disposed under the core unit, and the routing unit may include a plurality of routing wiring layers and a routing insulating layer disposed between the plurality of routing wiring layers.

In an example, the routing insulating layer may have a lower dielectric constant than the core layer.

In an example, the dielectric constant of the core layer may be 3.7 to 10.0, and the lower dielectric constant than the dielectric constant of the core layer may be 1.0 to 3.65.

An antenna substrate according to another embodiment may include a plurality of antenna areas arranged in a horizontal direction, wherein each of the plurality of antenna areas may include a core unit including a core layer and a core wiring layer stacked in a vertical direction and an antenna unit disposed on the core unit, the antenna unit may include a plurality of antenna wiring layers sequentially stacked on the core unit and an antenna insulating layer disposed between the plurality of antenna wiring layers, and the core layer may have a higher dielectric constant than the antenna insulating layer.

### Advantageous Effects

A hybrid antenna substrate according to an embodiment may have a small thickness, high isolation, a small length in the arrangement direction of a plurality of antenna areas, or a wide bandwidth.

### DESCRIPTION OF DRAWINGS

FIG. 1 illustrates a plan view of a hybrid antenna substrate according to an embodiment.

FIG. 2 illustrates a perspective view of the hybrid antenna substrate shown in FIG. 1.

FIG. 3 illustrates a cross-sectional view taken along line I-I′ in FIG. 1.

FIGS. 4A to 4D illustrate plan views of embodiments of one antenna area.

FIG. 5 illustrates a cross-sectional view of an embodiment of a core unit and an antenna unit shown in FIG. 3.

FIG. 6 illustrates a cross-sectional view of an antenna area of a hybrid antenna substrate according to a comparative example.

FIG. 7A is a graph indicating return loss of the hybrid antenna substrate of the comparative example, and FIG. 7B is a graph indicating return loss of the hybrid antenna substrate of the embodiment.

### BEST MODE

Hereinafter, the present disclosure will be described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure will be more thorough and complete, and will more fully convey the scope of the disclosure to those skilled in the art.

It will be understood that when an element is referred to as being “on” or “under” another element, it may be directly on/under the element, or one or more intervening elements may also be present. In addition, when an element is referred to as being “on” or “under”, “under the element” as well as “on the element” may be included based on the element. In addition, relational terms, such as “first”, “second”, “on/upper part/above”, and “under/lower part/below”, are used only to distinguish between one subject or element and another subject or element, without necessarily requiring or involving any physical or logical relationship or sequence between the subjects or elements.

Hereinafter, a hybrid antenna substrate 100 according to an embodiment will be described using the Cartesian coordinate system, but the embodiments are not limited thereto. That is, according to the Cartesian coordinate system, the x-axis, the y-axis, and the z-axis are orthogonal to each other. However, the embodiments are not limited thereto. That is, the x-axis, the y-axis, and the z-axis may intersect each other obliquely, rather than being orthogonal to each other. Hereinafter, for convenience of description, at least one of the x-axis direction or the y-axis direction will be referred to as a “horizontal direction”, and the z-axis direction will be referred to as a “vertical direction”.

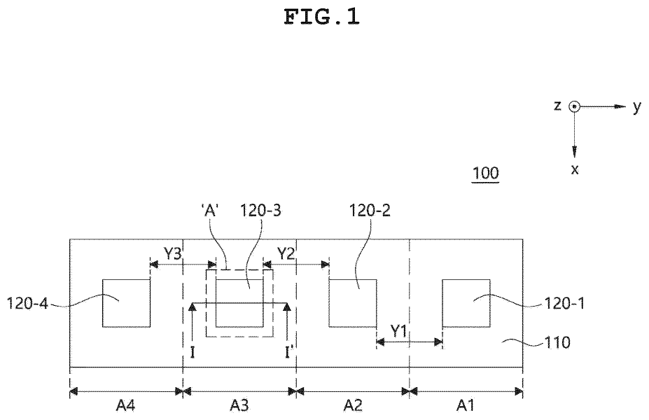

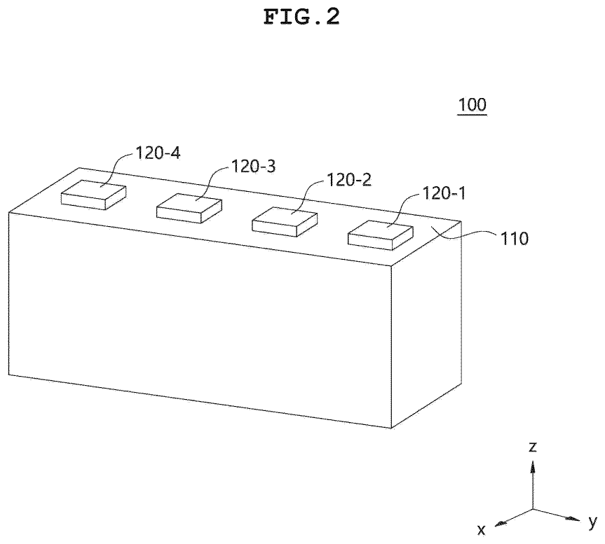

FIG. 1 illustrates a plan view of a hybrid antenna substrate 100 according to an embodiment, and FIG. 2 illustrates a perspective view of the hybrid antenna substrate 100 shown in FIG. 1.

The hybrid antenna substrate 100 according to the embodiment may include a plurality of antenna areas arranged in the horizontal direction. For example, as shown in FIGS. 1 and 2, the hybrid antenna substrate 100 may include first to fourth antenna areas A1, A2, A3, and A4 arranged in the y-axis direction, which is the horizontal direction. However, the embodiments are not limited thereto. That is, according to another embodiment, the hybrid antenna substrate 100 may include more than four or less than four antenna areas.

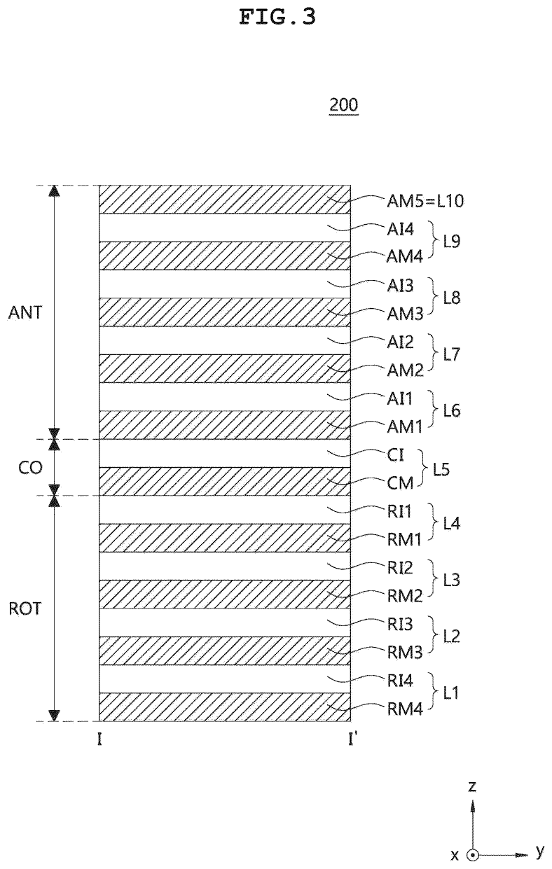

FIG. 3 illustrates a cross-sectional view taken along line I-I′ in FIG. 1.

Hereinafter, the configuration of the third antenna area A3 (hereinafter referred to as the “antenna area”) will be described with reference to FIG. 3. Each of the remaining antenna areas A1, A2, and A4 has the same configuration as the third antenna area A3, and thus redundant description thereof will be omitted.

The antenna area 200 according to an embodiment may include an antenna unit ANT and a routing unit ROT. According to another embodiment, the antenna area 200 may further include a core unit CO. That is, the core unit CO may be omitted from the antenna area 200.

The core unit CO may include a core layer CI and a core wiring layer CM stacked vertically. For example, as exemplarily shown in FIG. 3, the core layer CI may be disposed on the core wiring layer CM. Unlike what is shown, a core wiring layer CM may be additionally disposed on the core layer CI.

According to an embodiment, as shown in FIG. 3, the antenna unit ANT may be disposed on the core unit CO, the routing unit ROT may be disposed under the core unit CO, and the core unit CO may be disposed between the antenna unit ANT and the routing unit ROT.

According to another embodiment, the antenna unit ANT and the routing unit ROT may be disposed on the same horizontal plane.

According to still another embodiment, the routing unit ROT and the antenna unit ANT may be disposed so as to be spaced apart from each other and may be electrically connected to each other via a connection member, e.g., a flexible printed circuit board (FPCB).

Although the antenna unit ANT and the routing unit ROT of the antenna area 200 according to the embodiment will be described below as being disposed as shown in FIG. 3, the embodiments are not limited to any specific arrangement relationship between the antenna unit ANT and the routing unit ROT.

The antenna unit ANT may include a plurality of wiring layers (hereinafter also referred to as “antenna wiring layers”) and an insulating layer (hereinafter also referred to as an “antenna insulating layer”).

The plurality of antenna wiring layers may be sequentially stacked on the core unit CO, and the antenna insulating layer may be disposed between the plurality of antenna wiring layers.

According to the embodiment, the core layer CI may have a higher dielectric constant than the antenna insulating layer.

For example, the plurality of antenna wiring layers may include first to M^{th} wiring layers sequentially stacked upward in the vertical direction from the core unit CO. Here, M is a positive integer greater than or equal to 2. In this case, the antenna insulating layer may include first to N^{th} insulating layers having first to N^{th} dielectric constants, respectively. Here, 1≤N≤M−1. Among the first to N^{th} insulating layers, an n^{th} insulating layer may be disposed between the n^{th} wiring layer and the n+1^{th} wiring layer. Here, 1≤n≤N. The N^{th} wiring layer, as the uppermost insulating layer of the antenna unit ANT, may correspond to the top surface of the antenna unit ANT, as shown in FIGS. 1 and 2.

The antenna area 200 shown in FIG. 3 corresponds to a case in which M is 5 and N is 4. As shown, first to fifth wiring layers AM1, AM2, AM3, AM4, and AM5 may be sequentially stacked upward in the vertical direction from the core unit CO, and first to fourth insulating layers AI1, AI2, AI3, and AI4 may be disposed between adjacent ones of the first to fifth wiring layers AM1, AM2, AM3, AM4, and AM5. That is, the first insulating layer AI1 may be disposed between the first wiring layer AM1 and the second wiring layer AM2 and may have a first dielectric constant, the second insulating layer AI2 may be disposed between the second wiring layer AM2 and the third wiring layer AM3 and may have a second dielectric constant, the third insulating layer AI3 may be disposed between the third wiring layer AM1 and the fourth wiring layer AM4 and may have a third dielectric constant, and the fourth insulating layer AI4, which is the uppermost insulating layer, may be disposed between the fourth wiring layer AM4 and the fifth wiring layer AM5 and may have a fourth dielectric constant.

According to the embodiment, at least one of the first to N^{th} dielectric constants may be lower than the dielectric constant of the core layer CI.

For example, each of the first to N^{th} dielectric constants may be lower than the dielectric constant of the core layer CI.

Alternatively, each of the second to N^{th} dielectric constants may be lower than the dielectric constant of the core layer CI, and the first dielectric constant may be equal to or higher than the dielectric constant of the core layer CI.

Alternatively, each of the third to N^{th} dielectric constants may be lower than the dielectric constant of the core layer CI, and at least one of the first and second dielectric constants may be equal to or higher than the dielectric constant of the core layer CI.

Alternatively, the first to N^{th} dielectric constants may be equal to each other.

Alternatively, if the core unit CO is omitted from the antenna area 200 of the hybrid substrate according to the embodiment, at least one of the first to N^{th} dielectric constants may be different from the remaining dielectric constants.

Alternatively, the magnitudes of the first to N^{th} dielectric constants may gradually decrease in that order, as shown in Equation 1 below, or may gradually increase in that order, as shown in Equation 2 below.

$$Kb 1 > Kb 2 > Kb 3 > Kb 4 \qquad [ Equation 1 ]$$

$$Kb 4 > Kb 3 > Kb 2 > Kb 1 \qquad [ Equation 2 ]$$

In each of Equations 1 and 2, Kb1, Kb2, Kb3, and Kb4 represent the first dielectric constant, the second dielectric constant, the third dielectric constant, and the fourth dielectric constant, respectively.

According to an embodiment, the antenna wiring layer may include a short-range patch antenna and a long-range patch antenna.

The long-range patch antenna may be defined as a patch antenna that is disposed farther away from the core unit CO in the vertical direction than the short-range patch antenna. The long-range patch antenna may have a smaller surface area than the short-range patch antenna.

For example, referring to FIG. 3, assuming that the first wiring layer AM1 among the first to fifth wiring layers AM1 to AM5 is a short-range patch antenna, the second to fifth wiring layers AM2 to AM5 may correspond to long-range patch antennas. Alternatively, assuming that the first and second wiring layers AM1 and AM2 among the first to fifth wiring layers AM1 to AM5 are short-range patch antennas, the third to fifth wiring layers AM3 to AM5 may correspond to long-range patch antennas. In this way, the short-range patch antenna and the long-range patch antenna are merely relative concepts.

In this case, for convenience of description, among the insulating layers, an insulating layer located under the short-range patch antenna will be referred to as a “short-range insulating layer”, and an insulating layer located under the long-range patch antenna will be referred to as a “long-range insulating layer”.

According to an embodiment, the long-range insulating layer may have a lower dielectric constant than the short-range insulating layer.

According to another embodiment, the plurality of antenna wiring layers may include a lower wiring layer and an intermediate wiring layer. The lower wiring layer may be disposed on the core unit CO, and the intermediate wiring layer may be disposed on the lower wiring layer.

According to still another embodiment, the plurality of antenna wiring layers may further include an upper wiring layer. The upper wiring layer may be disposed on the intermediate wiring layer.

Among the first to N^{th} wiring layers, one of the first to M−2^{th} wiring layers may correspond to the lower wiring layer, one of the third to M^{th} wiring layers may correspond to the upper wiring layer, and one of the second to N−1^{th} wiring layers may correspond to the intermediate wiring layer. For example, referring to FIG. 3, one of the first to third wiring layers AM1, AM2, and AM3 may correspond to the lower wiring layer, one of the third to fifth wiring layers AM3, AM4, and AM5 may correspond to the upper wiring layer, and one of the second to fourth wiring layers AM2, AM3, and AM4 may correspond to the intermediate wiring layer.

If the plurality of antenna wiring layers includes a lower wiring layer and an intermediate wiring layer, one of the lower wiring layer and the intermediate wiring layer may include a low-band (LB) patch antenna, and the other of the lower wiring layer and the intermediate wiring layer may include a high-band (HB) patch antenna.

Alternatively, if the plurality of antenna wiring layers includes a lower wiring layer, an intermediate wiring layer, and an upper wiring layer, one of the lower wiring layer, the intermediate wiring layer, and the upper wiring layer may include a low-band patch antenna, another of the lower wiring layer, the intermediate wiring layer, and the upper wiring layer may include a high-band patch antenna, and the remaining one of the lower wiring layer, the intermediate wiring layer, and the upper wiring layer may include an additional patch antenna.

The third wiring layer AM3 may include an LB patch antenna as the lower wiring layer, the fourth wiring layer AM4 may include an HB patch antenna as the intermediate wiring layer, and the fifth wiring layer AM5 may include an additional patch antenna as the upper wiring layer.

Alternatively, the third wiring layer AM3 may include an additional patch antenna as the lower wiring layer, the fourth wiring layer AM4 may include an LB patch antenna as the intermediate wiring layer, and the fifth wiring layer AM5 may include an HB patch antenna as the upper wiring layer.

Alternatively, the third wiring layer AM3 may include an LB patch antenna as the lower wiring layer, the fourth wiring layer AM4 may include an additional patch antenna as the intermediate wiring layer, and the fifth wiring layer AM5 may include an HB patch antenna as the upper wiring layer.

According to the embodiment, the first to fourth antenna areas A1, A2, A3, and A4 may include first, second, third, and fourth additional patch antennas, respectively. FIGS. 1 and 2 exemplarily show a case in which an additional patch antenna is disposed on the uppermost wiring layer of each of the first to fourth antenna areas A1, A2, A3, and A4. That is, a first additional patch antenna 120-1 may be disposed on the fifth wiring layer AM5 of the first antenna area A1, a second additional patch antenna 120-2 may be disposed on the fifth wiring layer AM5 of the second antenna area A2, a third additional patch antenna 120-3 may be disposed on the fifth wiring layer AM5 of the third antenna area A3, and a fourth additional patch antenna 120-4 may be disposed on the fifth wiring layer AM5 of the fourth antenna area A4.

The first to fourth additional patch antennas may have different shapes or may have the same shape.

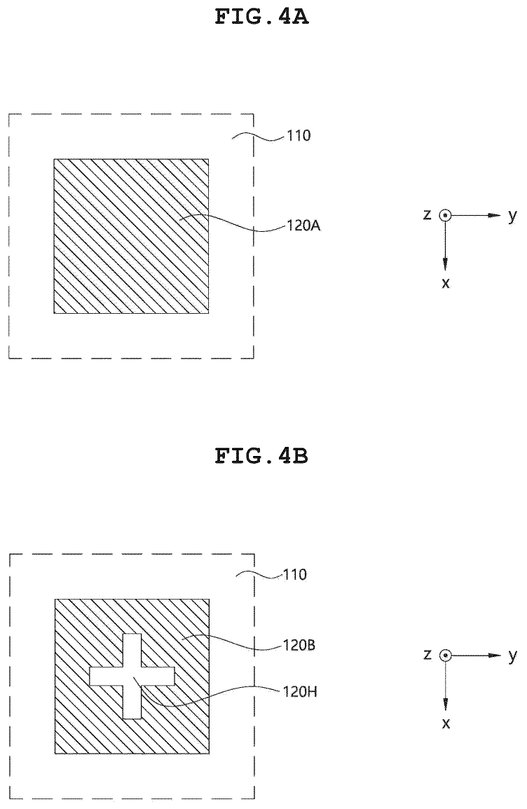

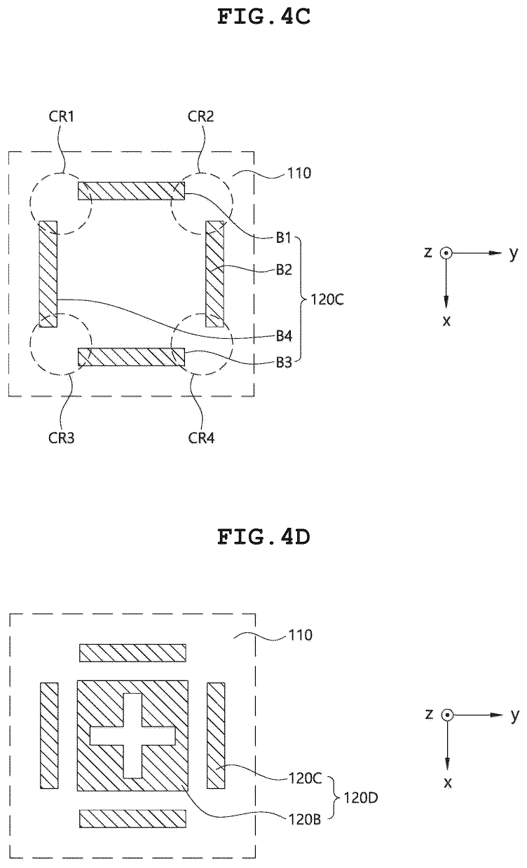

Hereinafter, various shapes of the first to fourth additional patch antennas (hereinafter referred to as “additional patch antennas”) will be described with reference to FIGS. 4A to 4D.

FIGS. 4A to 4D illustrate plan views 120A, 120B, 120C, and 120D of embodiments of one antenna area, which may correspond to portion “A” of the third antenna area A3 shown in FIG. 1.

Each of the additional patch antennas 120A, 120B, 120C, and 120D shown in FIGS. 4A to 4D may correspond to an embodiment of each of the first to fourth additional patch antennas 120-1, 120-2, 120-3, and 120-4 shown in FIGS. 1 and 2.

The additional patch antenna may include a first conductive antenna pattern layer having a polygonal, circular, or elliptical planar shape. For example, as shown in FIG. 4A, the first conductive antenna pattern layer 120A may have a rectangular planar shape.

Alternatively, the additional patch antenna may include a second conductive antenna pattern layer having a polygonal, circular, or elliptical planar shape with an open cavity therein. For example, as shown in FIG. 4B, the second conductive antenna pattern layer 120B may have a rectangular planar shape with an open cross-shaped cavity 120H therein.

Alternatively, the additional patch antenna may include a third conductive antenna pattern layer having a plurality of planar patterns formed on the same plane. For example, as shown in FIG. 4C, the third conductive antenna pattern layer 120C may have a rectangular planar shape with four cut-out corners CR1, CR2, CR3, and CR4. The third conductive antenna pattern layer 120C may include a plurality of bar-shaped patterns B1, B2, B3, and B4 spaced apart from each other.

Alternatively, the additional patch antenna may include at least two of the above-described first, second, and third conductive antenna pattern layers in combination.

For example, as shown in FIG. 4D, the additional patch antenna 120D may include, in combination, the second conductive antenna pattern layer 120B and the third conductive antenna pattern layer 120C having a planar shape that accommodates the second conductive antenna pattern layer 120B therein.

Meanwhile, the routing unit ROT may include a signal transmission line, and the plurality of wiring layers included in the routing unit ROT may include a signal pattern, a power pattern, or a resistance pattern. In addition, the routing unit ROT may have, in combination, various routing characteristics, such as power/data, input/output, and radio frequency (RF) routing.

The core wiring layer CM may be a main ground GND formed as a ground (GND) pattern, and the routing unit ROT may also have a ground pattern. Power may be supplied from the routing unit ROT to the antenna unit ANT through the core unit CO.

Similar to the antenna unit ANT, the routing unit ROT may also include a plurality of wiring layers (hereinafter also referred to as “routing wiring layers”) and an insulating layer (hereinafter also referred to as a “routing insulating layer”).

The routing insulating layer may be disposed between the plurality of routing wiring layers.

The plurality of routing wiring layers may include M+1^{th} to M+S^{th} wiring layers sequentially stacked downward in the vertical direction from the core unit CO. Here, S is a positive integer greater than or equal to 2. In this case, the routing insulating layer may include N+1^{th} to N+S^{th} insulating layers. The N+1^{th} insulating layer is disposed between the core unit CO and the N+2^{th} wiring layer and has an N+1^{th} dielectric constant. In addition, among the N+2^{th} to N+S^{th} insulating layers, an N+s^{th} insulating layer may be disposed between the N+s^{th} wiring layer and the N+s+1^{th} wiring layer and may have an N+s^{th} dielectric constant. Here, 2≤s≤S.

The antenna area 200 shown in FIG. 3 corresponds to a case in which M is 5, N is 4, and S is 4. As shown, sixth to ninth wiring layers RM1, RM2, RM3, and RM4 may be sequentially stacked downward in the vertical direction from the core unit CO, and fifth to eighth insulating layers RI1, RI2, RI3, and RI4 may be disposed between the core layer CO and the sixth to ninth wiring layers RM1, RM2, RM3, and RM4. That is, the fifth insulating layer RI1 may be disposed between the core unit CO and the sixth wiring layer RM1 and may have a fifth dielectric constant, the sixth insulating layer RI2 may be disposed between the sixth wiring layer RM1 and the seventh wiring layer RM2 and may have a sixth dielectric constant, the seventh insulating layer RI3 may be disposed between the seventh wiring layer RM2 and the eighth wiring layer RM3 and may have a seventh dielectric constant, and the eighth insulating layer RI4 may be disposed between the eighth wiring layer RM3 and the ninth wiring layer RM4 and may have an eighth dielectric constant.

The routing insulating layer according to the embodiment may have a lower dielectric constant than the core layer CI. At least one of the fifth to eighth dielectric constants shown in FIG. 3 may be lower than the dielectric constant of the core layer CI. For example, each of the fifth to eighth dielectric constants may be lower than the dielectric constant of the core layer CI.

In addition, the first to eighth dielectric constants may be equal to each other or may be different from each other.

According to the embodiment, the dielectric constant of the core layer CI may be 3.7 to 10.0, preferably 4.5 to 9.2, and more preferably 6.0 to 8.0.

In addition, among the first to eighth dielectric constants, a dielectric constant lower than the dielectric constant of the core layer CI may be 1.0 to 3.65, preferably 1.5 to 3.6, and more preferably 1.9 to 2.9. However, the embodiments are not limited thereto.

For example, the core layer CI may have a first high dielectric constant of 6.2, a second high dielectric constant of 7.2, or a third high dielectric constant of 9.0, a dielectric constant lower than the dielectric constant of the core layer CI, among the first to eighth dielectric constants, may be 3.53, and a dielectric constant not lower than the dielectric constant of the core layer CI, among the first to eighth dielectric constants, may be the first, second, or third dielectric constant. However, the embodiments are not limited thereto.

The material of each of the first to M+S^{th} wiring layers and the core wiring layer CM described above may include a metal such as copper (Cu), aluminum (Al), silver (Ag), tin (Sn), gold (Au), nickel (Ni), lead (Pb), titanium (Ti), or an alloy thereof.

The above-described first to fourth conductive antenna pattern layers (e.g., 120A, 120B, 120C, and 120D) may be disposed on a plane so as to overlap each other and may be coupled. In addition, the HB patch antenna, the LB patch antenna, and the additional patch antenna may be electrically connected to a radio frequency integrated circuit (RFIC) (not shown) through feeding patterns. However, the embodiments are not limited to any specific material of each of the first to M+S^{th} wiring layers and the core wiring layer CM. The RFIC may be disposed below, above, or next to the routing unit ROT.

The material of each of the first to N+S^{th} insulating layers and the core layer CI described above may be implemented as a material having insulating properties (hereinafter referred to as an “insulative material”). For example, as the insulative material, a thermosetting resin such as an epoxy resin, a thermoplastic resin such as polyimide, or a material including a reinforcing material such as glass fiber and/or an inorganic filler together therewith, for example, ABF, PID, BCC, or prepreg (PPG), may be used. However, the insulative material is not limited to a resin material. For example, a glass plate may be used, or a ceramic plate may be used. However, the embodiments are not limited to any specific material of each of the first to N+S^{th} insulating layers and the core layer CI. The thickness of the core layer CI may be larger than the thickness of each of the first to N+S^{th} insulating layers.

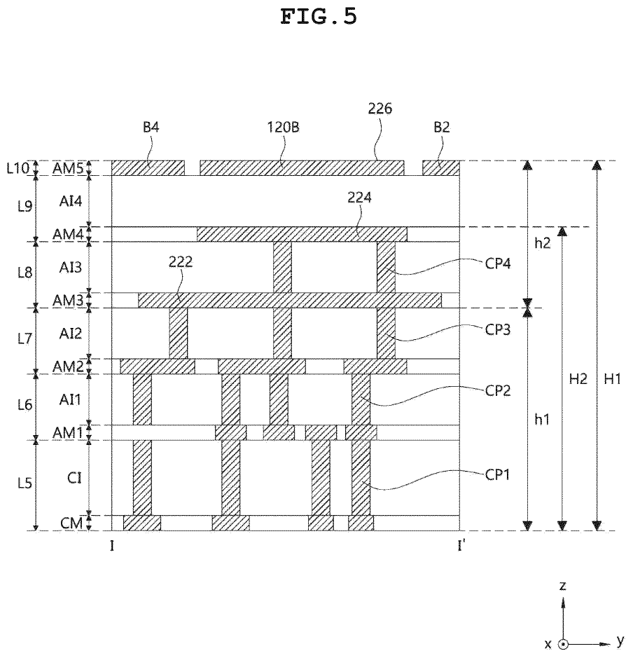

Meanwhile, the detailed configuration of the core unit CO and the antenna unit ANT in the antenna area 200 shown in FIG. 3 will be described in more detail with reference to FIG. 5.

FIG. 5 illustrates a cross-sectional view of an embodiment of the core unit CO and the antenna unit ANT shown in FIG. 3.

The antenna area according to the embodiment may include first to T^{th} layers L sequentially stacked in the vertical direction from the bottom of the routing unit ROT disposed under the core unit CO to the top of the antenna unit ANT disposed on the core unit CO. T=M+S+1. For example, as shown in FIG. 3, the antenna area 200 may include first to tenth layers (T=10) L1 to L10.

Each of the first to T^{th} layers may include at least one of a wiring layer and an insulating layer. For example, each of the first to T−1^{th} layers may include a wiring layer and an insulating layer disposed on the wiring layer, and the T^{th} layer may include only a wiring layer. As shown in FIG. 3, the wiring layers and the insulating layers may be alternately stacked in the vertical direction to implement a plurality of layers. The wiring layers stacked vertically may be electrically isolated from each other by the insulating layers.

Referring to FIG. 3, the first layer L1 may include a ninth wiring layer RM4 and an eighth insulating layer RI4 disposed on the ninth wiring layer RM4, the second layer L2 may include an eighth wiring layer RM3 and a seventh insulating layer RI3 disposed on the eighth wiring layer RM3, the third layer L3 may include a seventh wiring layer RM2 and a sixth insulating layer RI2 disposed on the seventh wiring layer RM2, and the fourth layer L4 may include a sixth wiring layer RM1 and a fifth insulating layer RI1 disposed on the sixth wiring layer RM1.

Referring to FIGS. 3 and 5, the fifth layer L5 corresponding to the core unit CO may include a core wiring layer CM and a core layer CI disposed on the core wiring layer CM, the sixth layer L6 may include a first wiring layer AM1 and a first insulating layer AI1 disposed on the first wiring layer AM1, the seventh layer L7 may include a second wiring layer AM2 and a second insulating layer AI2 disposed on the second wiring layer AM2, the eighth layer L8 may include a third wiring layer AM3 and a third insulating layer AI3 disposed on the third wiring layer AM3, the ninth layer L9 may include a fourth wiring layer AM4 and a fourth insulating layer AI4 disposed on the fourth wiring layer AM4, and the tenth layer L10 may include only a fifth wiring layer AM5.

Referring to FIG. 5, the antenna area may further include connection patterns (or wiring vias) that electrically connect the wiring layers included in the plurality of layers to each other.

For example, as shown in FIG. 5, the connection patterns may include a connection pattern CP1 interconnecting the wiring layer CM of the fifth layer L5 and the wiring layer AM1 of the sixth layer L6, a connection pattern CP2 interconnecting the wiring layer AM1 of the sixth layer L6 and the wiring layer AM2 of the seventh layer L7, a connection pattern CP3 interconnecting the wiring layer AM2 of the seventh layer L7 and the wiring layer AM3 of the eighth layer L8, and a connection pattern CP4 interconnecting the wiring layer AM3 of the eighth layer L8 and the wiring layer AM4 of the ninth layer L9. However, the embodiments are not limited to any specific number, shape, or arrangement position of the connection patterns.

The material of the connection patterns may be a metal such as copper (Cu), aluminum (Al), silver (Ag), tin (Sn), gold (Au), nickel (Ni), lead (Pb), titanium (Ti), or an alloy thereof. The connection patterns may include feeding vias that electrically connect the HB, LB, and additional patch antennas to the feeding patterns or electrically connect the feeding patterns disposed in different layers to each other. In addition, the connection patterns may include ground vias that electrically connect the ground patterns disposed in different layers to each other. In addition, the connection patterns may include signal vias, power vias, etc. The connection patterns may have a cylindrical shape or an hourglass shape, or may have a tapered shape in which the width thereof gradually decreases from the bottom thereof to the top thereof.

According to the embodiment, an HB patch antenna may be disposed in one of the eighth to tenth layers L8, L9, and L10 shown in FIG. 5, an LB patch antenna may be disposed in another of the eighth to tenth layers L8, L9, and L10, and an additional patch antenna may be disposed in the remaining one of the eighth to tenth layers L8, L9, and L10.

For example, referring to FIG. 5, an antenna 222 disposed in the eighth layer L8 may correspond to the LB patch antenna, an antenna 224 disposed in the ninth layer L9 may correspond to the HB patch antenna, and an antenna 226 disposed in the tenth layer L10 may correspond to the additional patch antenna.

Hereinafter, an antenna area of a hybrid antenna substrate according to a comparative example and the antenna area of the hybrid antenna substrate according to the embodiment will be described with reference to the accompanying drawings.

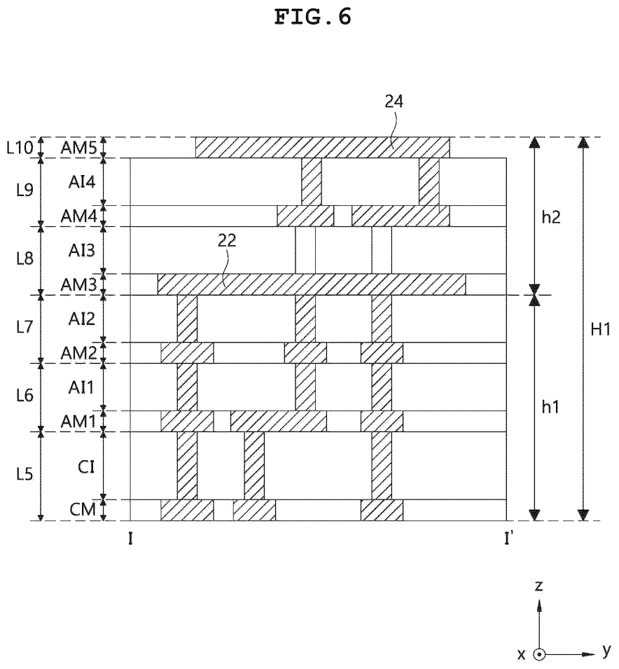

FIG. 6 illustrates a cross-sectional view of an antenna area of a hybrid antenna substrate according to the comparative example.

The antenna area according to the comparative example shown in FIG. 6 includes fifth to tenth layers L5 to L10, and each layer includes at least one of a wiring layer and an insulating layer, similar to the antenna area according to the embodiment shown in FIG. 5.

The dielectric constant of the antenna insulating layer included in the antenna area according to the comparative example shown in FIG. 6 is equal to the dielectric constant of the core layer CI, whereas the dielectric constant of the antenna insulating layer included in the antenna area according to the embodiment shown in FIG. 5 is lower than the dielectric constant of the core layer CI. In addition, the antenna area according to the comparative example shown in FIG. 6 includes an LB patch antenna 22 and an HB patch antenna 24, whereas the antenna area according to the embodiment shown in FIG. 5 includes the additional patch antenna 226 as well as the LB patch antenna 222 and the HB patch antenna 224. With this exception, the antenna area shown in FIG. 6 is the same as the antenna area shown in FIG. 5, and thus redundant description thereof will be omitted.

In each of FIGS. 5 and 6, a distance (or thickness) from the fifth layer L5 to the seventh layer L7 in the vertical direction will be referred to as a first thickness h1, and a distance from the eighth layer L9 to the tenth layer L10 in the vertical direction will be referred to as a second thickness h2.

In the comparative example, the dielectric constant of the core layer CI included in the fifth layer L5, which is the core unit CO, and the first to fourth dielectric constants of the antenna insulating layers AI1 to AI4 included in the layers L6 to L10 are equal to each other.

However, in the embodiment, the dielectric constant of the core layer CI is higher than at least one of the first to fourth dielectric constants. Accordingly, it is possible to reduce the thickness of the antenna area in the vertical direction while maintaining the performance of the hybrid antenna substrate including the antenna area, e.g., gain, at the same level as that of the comparative example, i.e., while having the same resonant frequency as the comparative example.

That is, even when the LB patch antenna 122 and the HB patch antenna 124 are disposed in the eighth and ninth layers L8 and L9, respectively, as in the embodiment shown in FIG. 5, the same performance may be ensured as when the LB patch antenna 22 and the HB patch antenna 24 are disposed in the eighth and tenth layers L8 and L10, respectively, as in the comparative example shown in FIG. 6. Accordingly, when the antenna area according to the embodiment does not include the tenth layer L10 shown in FIG. 5, the antenna area according to the embodiment may have a thickness H2 that is smaller than the thickness H1 of the antenna area of the comparative example by the thicknesses of the tenth layer L10 and the fourth insulating layer AI4 while having the same performance as the comparative example.

In addition, in the hybrid antenna substrate, isolation may be ensured when a distance between the patch antennas disposed in the antenna areas arranged in the horizontal direction is maintained at a predetermined distance.

In the case of the hybrid antenna substrate 100 according to the embodiment, since the dielectric constant of the core layer CI is higher than at least one of the first to fourth dielectric constants, it is possible to ensure the same isolation as the hybrid antenna substrate of the comparative example while reducing distances Y1, Y2, and Y3 between the patch antennas 120-1 to 120-4. Accordingly, the length of the hybrid antenna substrate according to the embodiment in the y-axis direction, which is the horizontal direction, may be reduced compared to the hybrid antenna substrate according to the comparative example.

Alternatively, when the distances Y1, Y2, and Y3 in the y-axis direction are set to be equal to those in the comparative example, isolation between adjacent antenna areas may be further improved.

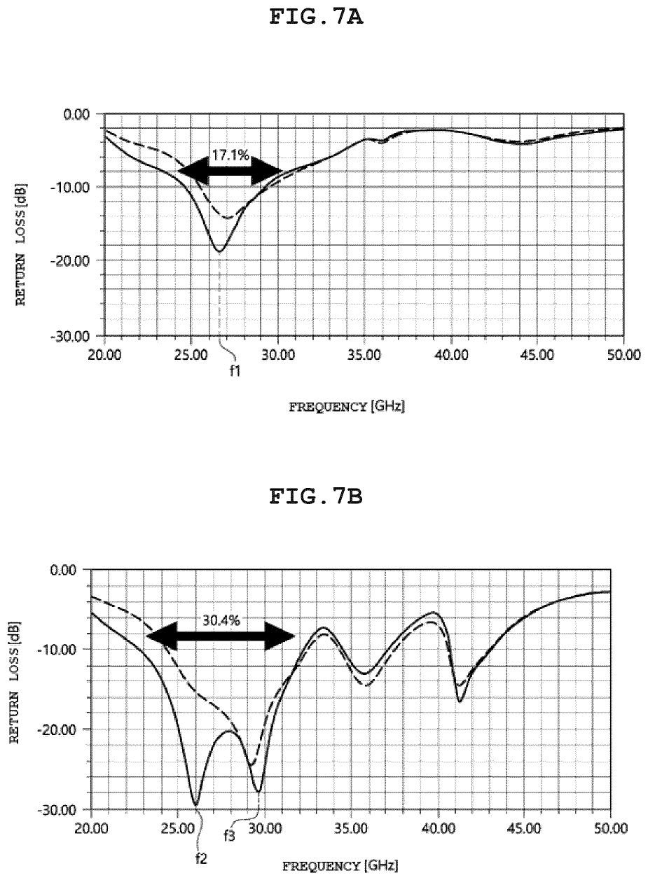

FIG. 7A is a graph indicating return loss of the hybrid antenna substrate of the comparative example, and FIG. 7B is a graph indicating return loss of the hybrid antenna substrate of the embodiment. In each of FIGS. 7A and 7B, the horizontal axis represents frequency, and the vertical axis represents return loss.

The return loss is a ratio of reflected voltage to input voltage, and the large absolute value thereof means low reflection and excellent matching. In general, a matching criterion may be set to −10 dB or lower.

The antenna area according to the embodiment may maintain the same thickness as the comparative example while further including the additional patch antenna. This is because, as described above, it is possible to place the additional patch antenna in the optional tenth layer L10 on the optional fourth insulating layer AI4 while ensuring the same performance as the comparative example.

When the LB patch antenna 22 and the HB patch antenna 24 are disposed in the eighth and tenth layers L8 and L10, respectively, as shown in FIG. 6, the return loss characteristics shown in FIG. 7A are obtained. In the case of the comparative example shown in FIG. 7A, there is one resonant frequency f1, and the fractional bandwidth (FBW) is merely 17.1% on the basis of −10 dB.

On the other hand, when the LB patch antenna 122 and the HB patch antenna 124 are disposed in the eighth and ninth layers L8 and L9, respectively, and the additional patch antenna 126 is disposed in the tenth layer L10, as shown in FIG. 5, and when the second and third conductive antenna pattern layers 120B and 120C shown in FIG. 4D are disposed as the additional patch antenna on the fourth insulating layer AI4, as shown in FIG. 5, the return loss characteristics shown in FIG. 7B may be obtained. In the case of the embodiment shown in FIG. 7B, it may be seen that there are two resonant frequencies f2 and f3 and the bandwidth of the low-band return loss within the commercial frequency range of the millimeter wave (mmWave) band is improved due to additional placement of the additional patch antenna 126. Referring to FIG. 7B, it may be seen that the fractional bandwidth in the embodiment is 30.4% on the basis of −10 dB, which is larger than that in the comparative example. Therefore, as compared to the comparative example, the frequency coverage in the embodiment increases, and thus the embodiment may be more usefully applied to a global network.

In addition, the additional patch antenna may be implemented in various shapes so that the hybrid antenna substrate according to the embodiment has desired performance.

For example, when the additional patch antenna is implemented as the first conductive antenna pattern layer exemplarily shown in FIG. 4A, efficiency of an antenna gain may increase. When the additional patch antenna is implemented as the second conductive antenna pattern layer exemplarily shown in FIG. 4B, the size of the patch antenna may be reduced. When the additional patch antenna is implemented as the third conductive antenna pattern layer exemplarily shown in FIG. 4C, the bandwidth may be increased.

As a result, the hybrid antenna substrate according to the above-described embodiment may have a smaller thickness than the comparative example, may have higher isolation than the comparative example, or may have a smaller length in the arrangement direction of the plurality of antenna areas than the comparative example.

Alternatively, the hybrid antenna substrate according to the embodiment has a wider fractional bandwidth than the comparative example.

While the present disclosure has been particularly shown and described with reference to exemplary embodiments thereof, these embodiments are only proposed for illustrative purposes, and do not restrict the present disclosure, and it will be apparent to those skilled in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

### MODE FOR INVENTION

Various embodiments have been described in the best mode for carrying out the disclosure.

### INDUSTRIAL APPLICABILITY

A hybrid antenna substrate according to the embodiment may be used in smartphones or the like.

1. A hybrid antenna substrate, comprising:
a core unit including a core layer and a core wiring layer stacked in a vertical direction; and
an antenna unit disposed on the core unit,
wherein the antenna unit includes:
a plurality of antenna wiring layers sequentially stacked on the core unit; and
an antenna insulating layer disposed between the plurality of antenna wiring layers, and
wherein the core layer has a higher dielectric constant than the antenna insulating layer.

2. The hybrid antenna substrate according to claim 1, wherein the antenna wiring layers include:
a short-range patch antenna; and
a long-range patch antenna disposed farther away from the core unit in the vertical direction than the short-range patch antenna, the long-range patch antenna having a smaller surface area than the short-range patch antenna,
wherein the antenna insulating layer includes:
a short-range insulating layer located under the short-range patch antenna; and
a long-range insulating layer located under the long-range patch antenna, and
wherein the long-range insulating layer has a lower dielectric constant than the short-range insulating layer.

3. The hybrid antenna substrate according to claim 1, wherein the plurality of antenna wiring layers includes:
a lower wiring layer disposed on the core unit; and
an intermediate wiring layer disposed on the lower wiring layer.

4. The hybrid antenna substrate according to claim 3, wherein one of the lower wiring layer and the intermediate wiring layer includes a low-band patch antenna, and
wherein a remaining one of the lower wiring layer and the intermediate wiring layer includes a high-band patch antenna.

5. The hybrid antenna substrate according to claim 3, wherein the plurality of antenna wiring layers further includes an upper wiring layer disposed on the intermediate wiring layer.

6. The hybrid antenna substrate according to claim 5, wherein one of the lower wiring layer, the intermediate wiring layer, and the upper wiring layer includes a low-band patch antenna,
wherein another of the lower wiring layer, the intermediate wiring layer, and the upper wiring layer includes a high-band patch antenna, and
wherein a remaining one of the lower wiring layer, the intermediate wiring layer, and the upper wiring layer includes an additional patch antenna.

7. The hybrid antenna substrate according to claim 6, wherein the additional patch antenna includes a first conductive antenna pattern layer having a polygonal, circular, or elliptical planar shape.

8. The hybrid antenna substrate according to claim 6, wherein the additional patch antenna includes a second conductive antenna pattern layer having a polygonal, circular, or elliptical planar shape with an open cavity therein.

9. The hybrid antenna substrate according to claim 6, wherein the additional patch antenna includes a third conductive antenna pattern layer having a plurality of planar patterns formed on the same plane.

10. The hybrid antenna substrate according to claim 6, wherein the additional patch antenna includes, in combination, at least two of:
a first conductive antenna pattern layer having a polygonal, circular, or elliptical planar shape;
a second conductive antenna pattern layer having a polygonal, circular, or elliptical planar shape with an open cavity therein; and
a third conductive antenna pattern layer having a plurality of planar patterns formed on the same plane.

11. The hybrid antenna substrate according to claim 1, wherein the plurality of antenna wiring layers includes first to M^{th} (M being a positive integer greater than or equal to 2) wiring layers sequentially stacked in a vertical direction from the core unit,
wherein the antenna insulating layer includes first to N^{th} (1≤N≤M−1) insulating layers having first to N^{th} dielectric constants, respectively, and
wherein an n^{th} (1≤n≤N) insulating layer is disposed between the n^{th} wiring layer and the n+1^{th} wiring layer.

12. The hybrid antenna substrate according to claim 11, wherein at least one of the first to N^{th} dielectric constants is lower than a dielectric constant of the core layer.

13. The hybrid antenna substrate according to claim 12, wherein the first to N^{th} dielectric constants are equal to each other.

14. The hybrid antenna substrate according to claim 11, wherein at least one of the first to N^{th} dielectric constants is different from the others.

15. The hybrid antenna substrate according to claim 11, wherein magnitudes of the first to NE dielectric constants gradually decrease in that order.

16. The hybrid antenna substrate according to claim 11, wherein the first dielectric constant is equal to or higher than a dielectric constant of the core layer, and
wherein each of the second to N^{th} dielectric constants is lower than a dielectric constant of the core layer.

17. The hybrid antenna substrate according to claim 11, wherein each of the first and second dielectric constants is equal to or higher than a dielectric constant of the core layer, and
wherein each of the third to N^{th} dielectric constants is lower than the dielectric constant of the core layer.

18. The hybrid antenna substrate according to claim 1, further comprising a routing unit disposed under the core unit,
wherein the routing unit includes:
a plurality of routing wiring layers; and
a routing insulating layer disposed between the plurality of routing wiring layers.

19. The hybrid antenna substrate according to claim 18, wherein the routing insulating layer has a lower dielectric constant than the core layer.

20. The hybrid antenna substrate according to claim 1, wherein a dielectric constant of the core layer is 3.7 to 10.0.

21. The hybrid antenna substrate according to claim 20, wherein a lower dielectric constant than a dielectric constant of the core layer is 1.0 to 3.65.

22. A hybrid antenna substrate, comprising a plurality of antenna areas arranged in a horizontal direction,
wherein each of the plurality of antenna areas comprises:
a core unit including a core layer and a core wiring layer stacked in a vertical direction; and
an antenna unit disposed on the core unit,
wherein the antenna unit comprises:
a plurality of antenna wiring layers sequentially stacked on the core unit; and
an antenna insulating layer disposed between the plurality of antenna wiring layers, and
wherein the core layer has a higher dielectric constant than the antenna insulating layer.
